(19) United States
(12) Patent Application Publication
(10) Pub. No.: US 2009/0114666 A1
(43) Pub. Date: May 7, 2009

(54) Laundry transfer system

(76) Inventors: James Christopher Thorpe, Panama City, FL (US); Richard Wesley Thrift, Panama City, FL (US); Mark Justin Warner, Lynn Haven, FL (US)

Correspondence Address: PAUL E. MILLIKEN, 9061 WALL STREET, NW, MASSILLON, OH, 44646-1676, US

(21) Appl. No.: 11/982,527

(22) Filed: Nov. 3, 2007

(51) Int. Cl. G07F 11/00; B65H 1/00

(52) U.S. Cl. 221/7; 221/133

(57) ABSTRACT

A laundry vacuum transfer system comprising a stock box (12 or 13), having an inlet (22) connectable to a passageway and an outlet (23) connectable to a vacuum means (24) for developing sub-atmospheric pressure within the box and along the passageway for drawing textile articles into the box via said inlet, the box having an upper door (27) dividing the box into upper and lower compartments (31,32) and a lower door (28) for controlling discharge of textile articles onto a compartmentalized transfer belt (15) located beneath the lower door (28)), and an accumulation bin (16 or 17) which receives laundry from the transfer belt (15), which is indexed to transport the laundry to the bin (16 or 17), the stock box having both compartments separately connected to the outlet via valve means (29).

### FIELD OF THE INVENTION

This invention relates to an apparatus for use in a laundry transfer system of the type used in a commercial laundry for moving textile articles around the laundry.

### BACKGROUND OF THE INVENTION

The commercial laundering and cleaning of articles, particularly in the linen supply field, require an accurate count of the number of articles being handled. The methods presently employed for counting articles vary from strictly manual sorting and counting to sophisticated devices which automatically sense, differentiate and count different types of articles. U.S. Pat. No. 4,849,999 discloses an apparatus and method in which items of laundry are sorted at a work station and then moved along an enclosed passageway to a collection box by vacuum. The number of items are counted by a sensor located in the passageway which counts the items during transfer along the passageway. The collection box is discharged onto a conveyor when a predetermined number of items have been collected into the bin.

A problem with the system described in U.S. Pat. No. 4,849,999 is that the transfer of laundry items must temporarily cease during the emptying of the collection box so as not to render the count inaccurate.

The present invention provides a collection box, also known as a stock box, to which, laundry items can be continuously transferred without temporary interruptions for discharging. The invention also provides for a laundry transfer system in which separated textile articles are moved around in separated batches of laundry.

### STATEMENTS OF THE INVENTION

According to a first aspect of the present invention there is provide a collection box or use in a laundry vacuum transfer system and which comprises an enclosed box having an inlet connectable to a passageway and an outlet connectable to a vacuum means for developing sub-atmospheric pressure within the box and along the passageway for drawing textile articles into the box via said inlet, an upper door dividing the box into upper and lower compartments, a lower door controlling discharge of said textile articles from the box, both compartments being separately connected to the outlet with valve means connecting one or the other of said compartments to the outlet, but not both.

In use, textile articles are drawn through one end of the passageway and through the passageway into the box via the inlet, and sensor means in the passageway count the textile articles drawn through the passageway into the box.

The upper and lower doors are substantially horizontal sliding doors which are displaceable by actuators to open and close the respective compartments. The actuators may be any suitable form of actuator e.g. pneumatic, hydraulic, electrical etc. The preferred actuators are double acting pneumatic actuators.

The upper doors divides the outlet into upper and lower passages which are connected to the respective upper and lower compartments and the valve means comprises a flap which is operable to close off one or the other of said upper and lower passages from the vacuum means.

The vacuum means comprises an exhaust fan mounted on the rear of the box, and preferably the fan exhaust is connected into a filter unit.

The stock box comprises sidewalls which are lined with mesh panels.

According to another aspect of the present invention there is provided a laundry transfer system comprising at least one stock box according to the first aspect of the invention, a compartmentalized transfer belt located beneath the lower door of the stock box, and at least one accumulation bin which receives laundry from the transfer belt, the stock box discharging laundry into a compartment of the belt, and the transfer belt being indexed to transport the laundry to the bin.

The transfer system may further comprise a pair of stock boxes arranged side by side, a pair of accumulation bins arranged side by side and a diverter means, the transfer belt moving compartments into a location above the two accumulation bins, with the textile articles in the compartments being transversely displaceable from the transfer belt into a selected one of said pair of collection bins by said diverter means.

The diverter means comprises a pair of spaced apart pusher plates held on a sub-frame and located adjacent each side of the transfer belt, the sub-frame and pusher plates being moveable to displace the textile items into on or other of the two accumulation bins.

According to yet another aspect of the invention there is provided a diverter apparatus for moving pieces of laundry from a conveyer belt into accumulation bins located beneath the belt, the diverter comprising a fixed frame disposed above the bins, a second frame and a pair of substantially vertical plates held in spaced relationship by the second frame to be adjacent the sides of the belt, the second frame being moveable relative to the first frame so that the plates sweep any textile article from the belt into one of said bins.

The sub frame is displaced relative to the first frame by two double acting actuators, the two actuators being connected with one actuator having its piston connected to the first frame and the second actuator having its piston connected to the sub-frame,

The two double acting actuators are preferably pneumatic actuators working in opposition to each other.

The invention further includes the method of moving and counting pieces of laundry accomplished by the apparatus.

The invention further provides a method of moving counted textile articles through a stock box as described above wherein vacuum is connected to the lower compartment and the counted articles pass through the inlet to accumulate in the lower compartment, and when the lower compartment is full, the upper door closes and simultaneously the vacuum changes to the upper compartment and the textile articles are now pulled and counted into the upper compartment, the laundry (textile articles) accumulated in the lower compartment is discharged through the lower door, once the laundry has been discharged the lower door is closed, the upper door is opened vacuum switched to the lower compartment and the counted articles are dropped into the lower compartment and further articles counted through until the pre-determined number is reached when the cycle is repeated.

Yet another aspect of the invention comprises a method of moving counted textile articles through a laundry transfer system as described above, wherein the counted articles pass into a stock box having upper and lower compartments separately connectable to a vacuum means, and doors for discharge of laundry in the lower compartment, wherein vacuum is connected to the lower compartment and counted articles accumulated in the lower compartment, and when the lower compartment is full, the vacuum is switched to the upper compartment and counted articles are now accumulated in the upper compartment, the laundry (textile articles) accumulated in the lower compartment is discharged onto the compartmentalized conveyor, once the laundry has been discharged, the lower door is closed, and the vacuum is switched again to the lower compartment, the counted articles in the upper compartment drop into the lower compartment and further articles counted through until the pre-determined number is reached when the cycle is repeated, the load is discharged into a known compartment on the transfer belt which is indexed to move the belt towards the bins, the belt being paused to permit a further discharges of laundry into other compartment on the belt and to permit operation of the diverter means, which sweep the laundry in a specified compartment to one side or the other of the belt into a selected accumulation bin

### DETAILED DESCRIPTION OF THE DRAWINGS

The invention will be described by way of Example and with reference to the following drawings in which:

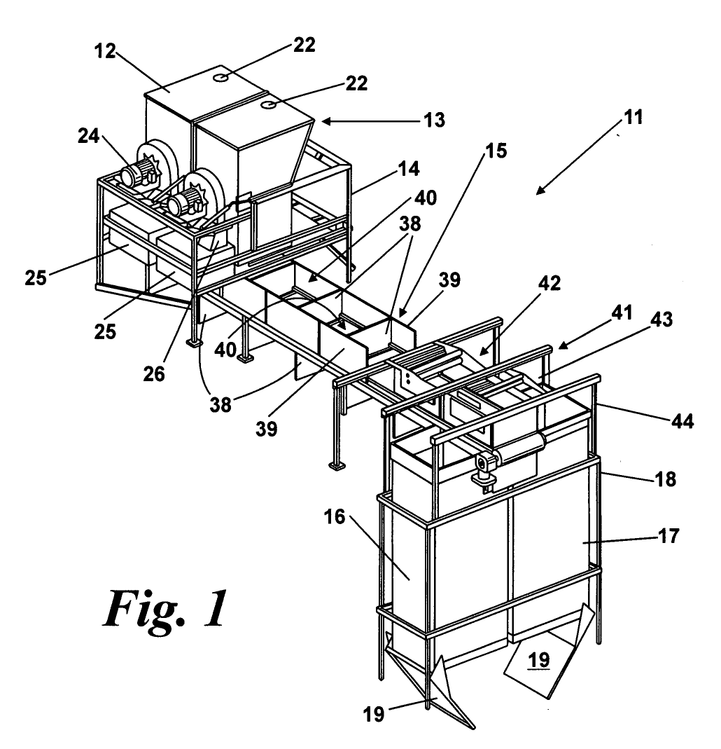

FIG. 1 is an isometric view of a laundry transfer system according to one aspect of the present invention,

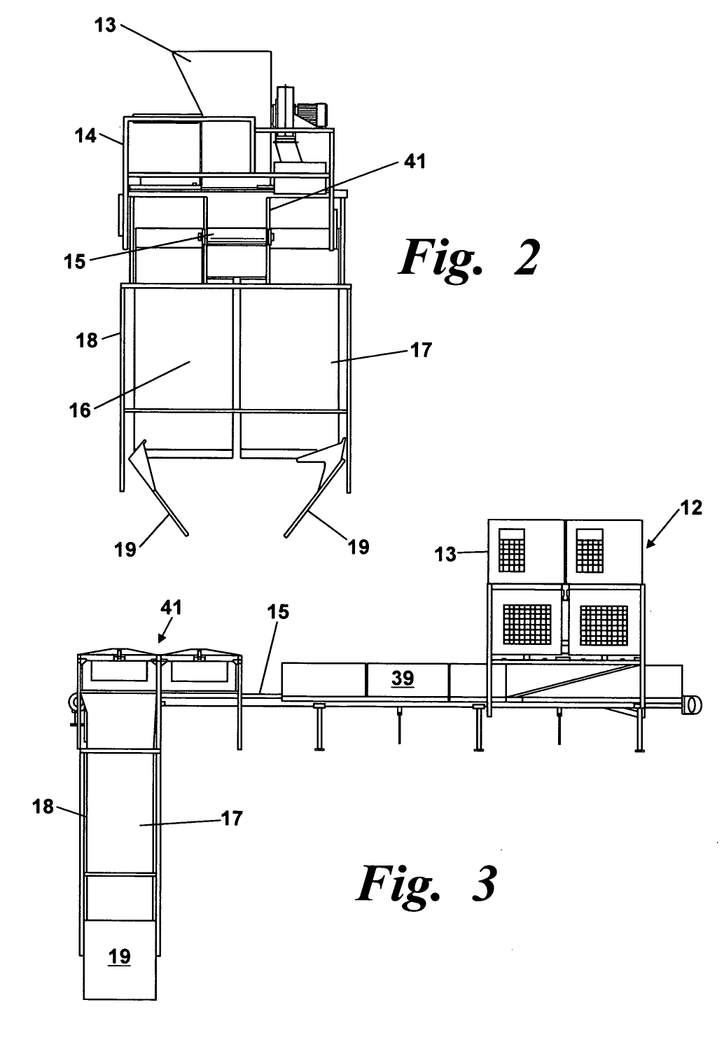

FIG. 2 is an end view of the system shown in FIG. 1,

FIG. 3 is a side elevation of the system shown in FIG. 1

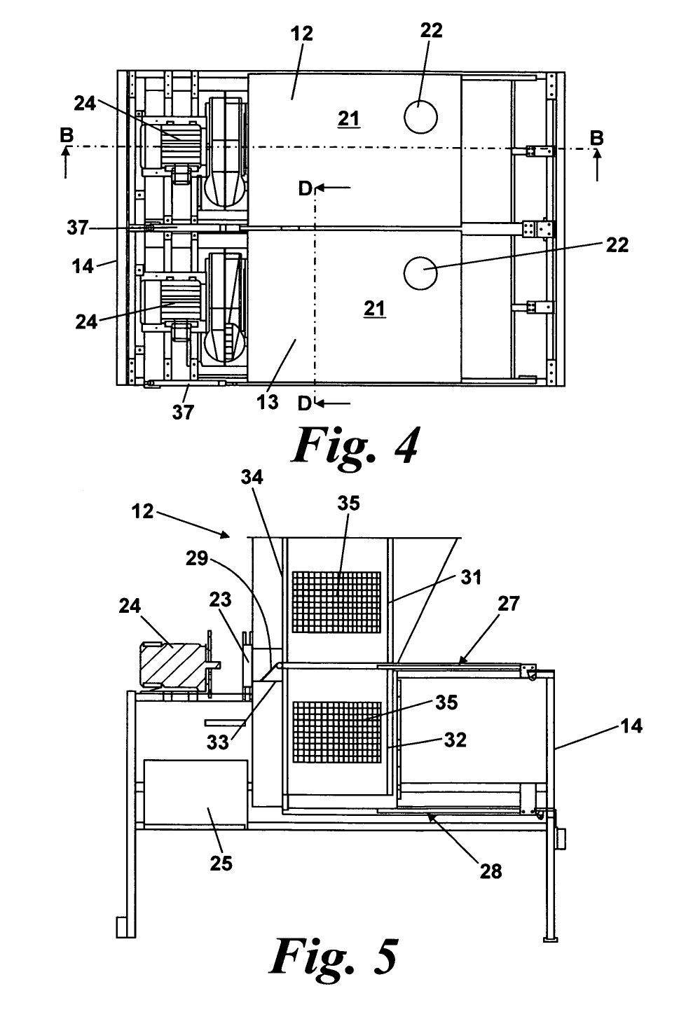

FIG. 4 is a plan view of a collection box used in the system shown in FIG. 1 and which is in accordance with another aspect of the invention,

FIG. 5 is a section on the line B-B of FIG. 4,

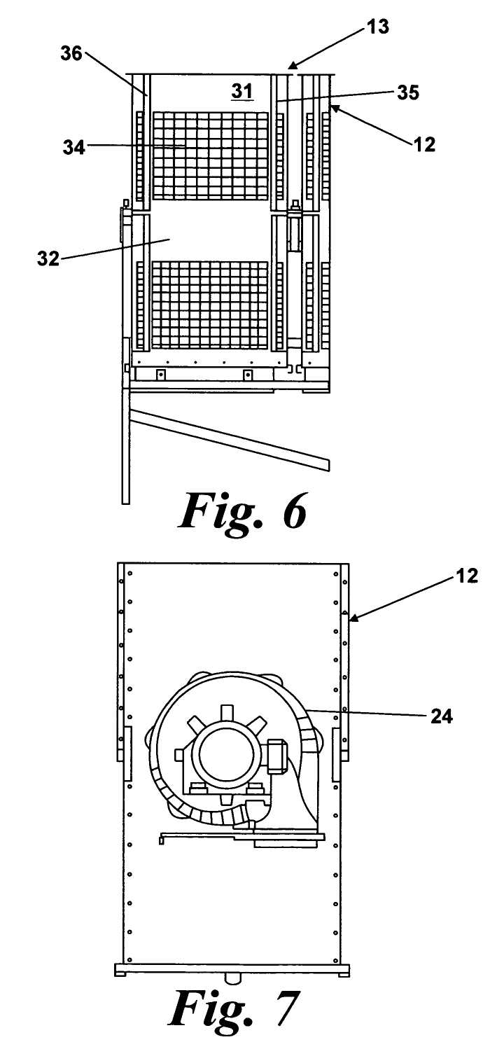

FIG. 6 is a section on the line D-D of FIG. 4

FIG. 7 is a rear view of the collection box of FIG. 4,

FIG. 8 is a plan view of the diverter used in the system shown in FIG. 1 and which is in accordance with a further aspect of the invention,

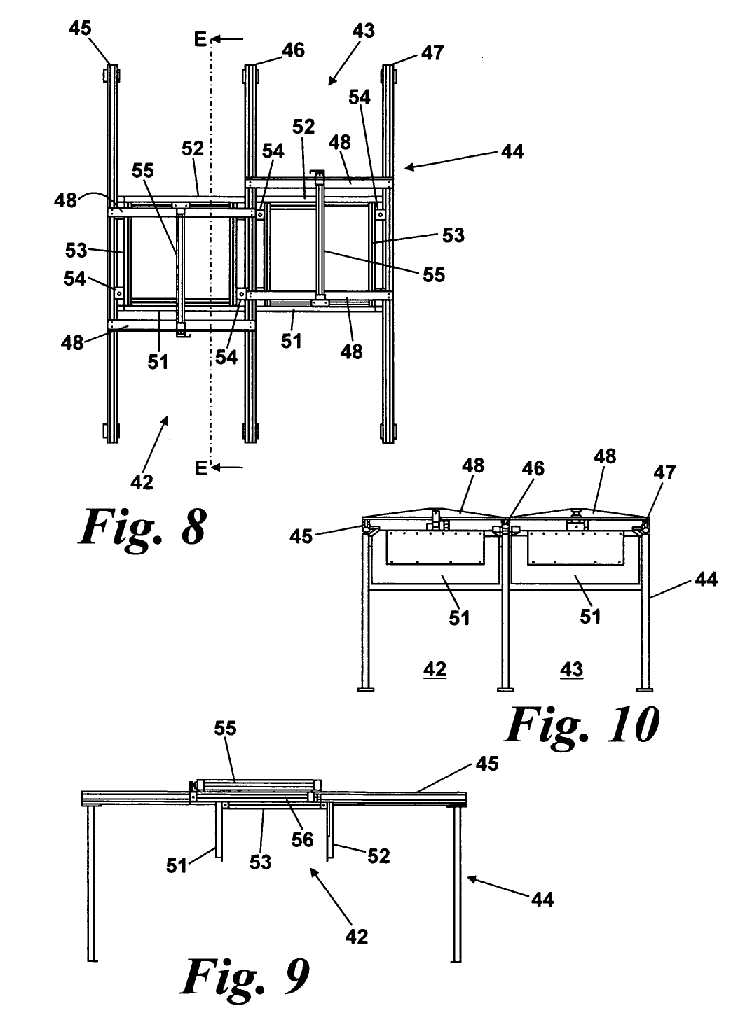

FIG. 9 is a section on the line E-E shown in FIG. 8, and

FIG. 10 is a side view of the diverter shown in FIG. 8.

### DETAILED DESCRIPTION OF THE INVENTION

With reference to FIG. 1 to 3 of the drawings, there is shown a laundry transfer system 11 which includes at least one collection boxes (sometimes called stock boxes) 12,13 mounted on a frame 14 to which sorted textile articles are delivered. In the present example two stock boxes 12,13 are used in the system but any number of stock boxes may be used as is desired.

Mixed laundry is delivered to a work station, or sorting table, (not shown) and sorted manually. The sorting table is connected by respective passageways (not shown) to the stock bins 12,13. Laundry is sorted on the table and selected articles are transferred via select passageways to a respective stock box 12, or 13 by vacuum means. The number of textile article transferred through each passageway is counted by optical sensors (not shown) which monitor the movement of textile articles through the passageways. The sorting table and passageways utilized with the present invention are substantially as described U.S. Pat. No. 4,819,999 the contents of which are hereby incorporated into the present description.

Separated textile articles from the boxes 12,13 are deposited onto an endless transfer belt 15 and moved towards a plurality of accumulation bins (or collection bins) 16 & 17 mounted in a frame 18. The present system shows the use two accumulation bins 16,17 but any number of bins may be used as is required. The textile articles on the transfer belt 15 are displaced into a selected one of the two accumulation bins 16 or 17 by a diverter means 41. The two bin 17 & 18 are emptied through doors 19 located in the bottoms of the bins.

The two stock boxes 12, 13 are identical and therefore details described for one box will be applicable to both collection boxes. With reference to FIGS. 4 to 7, the two stock box 12 and 13 each comprise an enclosed hollow box having a removable lid 21 with an inlet 22 therein which is connectable to a respective passageway. The box 12 has an outlet 23 in its rear wall which is connectable to a vacuum means 24 for developing sub-atmospheric pressure within the box 12 and along the respective passageway for drawing air and textile articles into the box via said inlet 22. The vacuum means comprises an exhaust fan 24 mounted on the rear of the box 12 and connected directly to the outlet 23. The exhaust from the fan 24 may be connected into a filter unit 25 via ducting 26 (see FIG. 1) which reduces noise and cleans the air prior to introduction into the laundry.

The box 12 is divided into upper and lower compartments 31,32 by an upper door 27. A lower door 28 controls the discharge of said textile articles from the box 12. The outlet 23 in the rear wall is arranged to span the upper door 27 so that both compartments 31,32 are separately connected to the outlet 23 with a valve means 29 connecting one or the other of said compartments 31,32 to the outlet 23, but not both. The valve means 29 comprises a flap 29 housed in a duct 33 so that when the flap 29 is in a upward inclination the lower compartment 32 is connected to vacuum means 24 and when the flap 29 is inclined downwardly the upper compartment 31 is connected to the vacuum means 24.

The compartments 31,32 of each box 12,13 are lined with mesh panels 34,35,36 spaced inwardly from the rear wall and sidewalls. The rear mesh panel 34 prevents textile articles being drawn into the outlet 23 and the side panels 34,35 allow air flow if the rear mesh becomes covered in textile articles.

The upper and lower doors 27,28 are sliding doors are guided for movement by slide ways in the boxes and the frame 14 and are moved by double acting actuators 37, preferably pneumatic cylinders. The position of the doors may be determined by door position sensors as is well known.

The two stock boxes 12,13 are mounted above one end portion of the transfer belt 15, the other end of which is arranged above the two accumulation bins 16 & 17. Longitudinally extending guide walls 39 are fixed on each side of the belt 15 to retain the laundry on the belt 15 as far as the diverter means 41. The transfer belt 15 is divided into discrete compartments 40 by transverse partitions 38. The movement of the belt 15 is controlled so as to index forward towards the bins 16 & 17, after a predetermined time period, pausing for a time period to allow for discharge of laundry from the stock boxes 12 & 13 into selected compartments 40 on the belt 15 and for discharge from the belt into a selected one of the bins 16 & 17. It has been found that indexing for three seconds followed by a pause of tow seconds is suitable for the present system, but this may vary depending on the number of stock boxes and accumulation bins used.

The diverter means 41 is arranged above the accumulation bins 16 & 17 with the transfer belt 15 passing through the diverter means 41. With reference now to FIGS. 8 to 10, the diverter means 41 shown comprises two diverters 42,43 which in use can be utilised in combination with four accumulation bags. In the present example only one diverter 43 is in use with two accumulation bags 16 & 17. The two diverters 42,42 are identical and details describes for one diverter are applicable to both diverters. The two diverters 42,43 are arranged within a frame 44 which in use sits above the frame 18 for the bins 16 & 17.

The frame 44 comprises transverse guide rails 45-47 (transverse with respect to the transfer belt 15) held in spaced apart relationship by cross beans 48. The guide rails 45-47 are sufficiently high above the belt 15 to permit the partitions to pass through without interference. The diverter 42 is located between the two guide rails 45,46 and the diverter 43 is located between the guide rails 46,47. Each diverter 42,43 comprises a pair of plates 51,52 which are held in a spaced apart relationship on a rectangular sub-frame 53. The two plates 51, 52 are spaced apart by the width of the belt 15 and are a sliding fit between the partitions 38 on the belt 15. The two plates 51,52 in their neutral position act to retain the laundry on the belt 15 in the absence of the guide walls 39. Each sub-frame 53 is slidingly mounted for transverse movement between pairs of respective guide rails by bearing blocks 54.

Each sub-frame 53 is moved relative to its respective guide rails 45, 46 or 46,47 by a pair of double acting actuators 55,56, preferably pneumatic cylinders. One actuator 55 is fixed at one end to a frame cross-members 48 with its piston fixed to the other actuator 56 which has its piston is fixed to the sub-frame 53. The actuators 55,56 are operated such that when both actuators are retracted the plates 51,52 are in their neutral position adjacent the sides of the belt 15 allowing the belt to pass freely through the diverter means 41. The movement of the sub-frame 53 to each side of the belt 15 is achieved by extension of one or other of the two actuators as is required. The total movement of the sub-frame 53 in each direction may be controlled by the use of sensors as is well known and the movement of the pistons within actuators 55, 56 may be cushioned.

The operation of the laundry transfer system 11 is controlled by a programmable control (not shown) which is connected to at least the vacuum means 24 including the control flap 29, the sensors in the passageway to the stock bins. the actuators 27,27 for the sliding doors on the stock bins, door position sensors, the diverter actuators 55,56, diverter position sensors and to an operations control system for the transfer belt.

The starting condition for each stock box 12 or 13 is with the upper door open 27 and the lower door 28 closed. The vacuum means control flap 29 is inclined upwardly so that vacuum pulls single textile articles through the respective passageway where the articles are counted and pass through the inlet 22 of the stock box 12 or 13 to accumulate in the lower compartment 32. When the lower compartment is full, that is contains a predetermined number of articles, the upper sliding door 27 closes and simultaneously the valve 39 changes to the downward inclination to connect the upper compartment 31 to the vacuum means 24. The textile articles are now pulled and counted into the upper compartment 31.

The laundry accumulated in the lower compartment is discharged onto the transfer belt. This is facilitated by the lack of vacuum in the lower compartment. Once the laundry has been discharged the lower sliding door 28 is closed, the upper door 27 is opened and the flap valve 29 re-orientated to the upward inclination to connect the lower compartment 32 to the vacuum. The counted articles are dropped into the lower compartment 32 and further articles counted through until the pre-determined number is counted is reached when the cycle is repeated. The counted laundry in a stock box is typically of a particular category and the load is discharged into a known compartment on the transfer belt 15. The transfer belt 15 is indexed to move the belt by one or two compartments 40 at a time depending on the number of stock boxes and diverters in operation. The belt is then paused to permit a further discharge of laundry into another compartment 40 on the belt and to permit operation of a diverter 42 or 43. Each diverter is controlled to sweep the laundry in a specified compartment 40 to one side or the other of the belt 15 into a selected accumulation bin 16 o17. The accumulation bins may be discharged through doors 19 when a particular bin has collected a predetermined amount of a particular category of laundry.

What is claimed is:

1. A stock box for use in a laundry vacuum transfer system and which comprises an enclosed box having an inlet connectable to a passageway and an outlet connectable to a vacuum means for developing sub-atmospheric pressure within the box and along the passageway for drawing textile articles into the box via said inlet, an upper door dividing the box into upper and lower compartments, a lower door controlling discharge of said textile articles from the box, both compartments being separately connected to the outlet with valve means connecting one or the other of said compartments to the outlet, but not both.

2. A stock box as claimed in claim 1, wherein the upper and lower doors are substantially horizontal sliding doors which are displaced by actuators to open and close the respective upper and lower compartments.

3. A stock box as claimed in claim 2, wherein the upper doors divides the outlet into upper and lower passages which are connected to the respective upper and lower compartments by said the valve means.

4. A stock box as claimed in claim 3 wherein the valve means comprises a flap which is operable to close off one or the other of said upper and lower passages from the vacuum means.

5. A stock box as claimed in claim 1 wherein the vacuum means comprises an exhaust fan connected to the outlet and mounted on the rear of the box.

6. A stock box as claimed in claim 5 wherein the fan exhaust into a filter unit.

7. A stock box as claimed in claim 1 wherein the box further comprises sidewalls which are lined with mesh panels.

8. A laundry transfer system comprising at least one stock box as claimed in claim 1, a compartmentalized transfer belt located beneath the lower door of the stock box, and at least one accumulation bin which receives laundry from the transfer belt, the stock box discharging laundry into a compartment of the belt, and the transfer belt being indexed to transport the laundry to the bin.

9. A laundry system as claimed in claim 8 comprising a pair of stock boxes arranged side by side and a pair of accumulation bins arranged side by side, the transfer belt moving its compartments into a location above the pair of bins, and a diverter means is provided for transversely displacing textile articles in a compartment from said compartment into a selected one of said pair of bins.

10. A laundry system as claimed in claim 9 wherein diverter means comprises a pair of spaced apart pusher plates held on a sub-frame and located adjacent each side of the transfer belt, the sub-frame and pusher plates being moveable to displace the textile items into on or other of the two collection bins.

11. A diverter apparatus for moving pieces of laundry from a compartmentalized transfer belt into accumulation bins located beneath the belt, the diverter comprising a fixed frame disposed above the bins, a sub-frame and a pair of substantially vertical plates held in spaced apart relationship by the sub-frame above the belt and adjacent the sides of the belt, the sub-frame being moveable relative to the first frame to one side or other of the belt so that the plates sweep any textile article from the belt into one of said bins.

12. A diverter apparatus as claimed in claim 11 wherein the sub frame is displaced relative to the first frame by two double acting actuators, the two actuators being connected with one actuator having its piston connected to the first frame and the second actuator having its piston connected to the sub-frame,

13. A method of moving and counting textile articles accomplished by the transfer system as claimed in claim 8.

14. A method of moving counted textile articles through a stock box as claimed in claim 1 wherein vacuum is connected to the lower compartment and the counted articles pass through the inlet to accumulate in the lower compartment, and when the lower compartment is full, the upper door closes and simultaneously the vacuum is connected the upper compartment and textile articles are now counted into the upper compartment, laundry (textile articles) accumulated in the lower compartment is discharged through the lower door which is then closed, the upper door is opened and vacuum is switched to the lower compartment and the counted articles are dropped into the lower compartment and further articles counted through until the pre-determined number is reached when the cycle is repeated.

15. A method of moving counted textile articles through a laundry transfer system as claimed in claim 8 wherein counted articles pass into a stock box having upper and lower compartments separately connectable to a vacuum means, and doors for discharge of laundry in the lower compartment, wherein vacuum is connected to the lower compartment and counted articles accumulate in the lower compartment, and when the lower compartment is full, the vacuum is switched to the upper compartment and the counted articles are now accumulated in the upper compartment, the laundry (textile articles) accumulated in the lower compartment is discharged onto the compartmentalized conveyor, once the laundry has been discharged the lower door is closed, and the vacuum is switched again to the lower compartment, any counted articles in the upper compartment drop into the lower compartment and further articles are counted through until the pre-determined number is reached when the cycle is repeated, the load is discharged into a known compartment on the transfer belt which is indexed to move the belt towards the bins, the belt being paused to permit discharges of laundry into other compartment on the belt and to permit operation of the diverter means, which sweeps the laundry from a specified compartment to one side or the other of the belt into a selected accumulation bin.
